(19) United States
(12) Patent Application Publication
(10) Pub. No.: US 2022/0366374 A1
(43) Pub. Date: Nov. 17, 2022

(54) SYSTEM, METHOD, AND COMPUTER PROGRAM FOR IDENTIFYING IMPLIED JOB SKILLS FROM QUALIFIED TALENT PROFILES

(71) Applicant: Eightfold AI Inc., Santa Clara, CA (US)

(72) Inventors: Niran Kundapur, Santa Clara, CA (US); Sanjeet Hajarnis, Santa Clara, CA (US); Yi Ding, Santa Clara, CA (US); Varun Kacholia, Santa Clara, CA (US)

(73) Assignee: Eightfold AI Inc., Santa Clara, CA (US)

(21) Appl. No.: 17/742,278

(22) Filed: May 11, 2022

Related U.S. Application Data
(60) Provisional application No. 63/187,076, filed on May 11, 2021.

(51) Int. Cl. G06Q 10/10; G06Q 10/06; G06F 40/30; G06F 40/289; G06N 3/04

(52) U.S. Cl. CPC G06Q 10/1053; G06Q 10/06398; G06F 40/30; G06F 40/289; G06N 3/04

(57) ABSTRACT

A system and method include one or more processing devices to obtain a job description comprising requirements for a job, identify, based on at least one requirement in the job description, qualified talent profiles that each characterizes a corresponding qualified person for the job, calculate, by applying a deep neural network to each of the qualified talent profiles, embedding vectors, determine a cluster of embedding vectors based on a similarity distance metric, determine linguistic units in a group of the qualified talent profiles, and determine implied traits based on traits explicitly specified in the job description and common traits among the group of qualified persons.

### REFERENCE TO RELATED APPLICATIONS

This application claims priority benefit to U.S. Provisional Application No. 63/187,076 filed on May 11, 2021.

### TECHNICAL FIELD

The present disclosure relates to improvements to computer technologies such as machine learning in natural language processing (NLP), and in particular to a system, method, and storage medium including executable computer programs for identifying implied job skills from qualified talent profiles and enhancing a job description.

### BACKGROUND

An organization such as a company may need to hire in the job marketplace to fill job openings. To achieve the hiring goals, the organization may post these job openings in the media such as the company's career website, printing media, or other social network sites. These posts of job openings may include job descriptions. A job description may include a job title, requisite skills, years of experience, education levels, and desirable personality traits. The job description is typically drafted by a human resource (HR) manager who may specify the job title, requisite skills, years of experience, education levels, and desirable personality traits based on the HR manager's personal evaluation and judgement.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates a computing system implementing a software application for identification of implied skills according to an implementation of the disclosure.

FIG. 2 illustrates a neural network module that may be used to calculate embedding vectors according to an implementation of the disclosure.

FIG. 3 illustrates a Bidirectional Encoder Representations from Transformers (BERT) model that may be trained to convert words or phrases into embedding vectors according to an implementation of the disclosure.

FIG. 4 illustrates a system for comparing the job description with qualified talent profiles using embedding vectors according to an implementation of the disclosure.

FIG. 5 illustrates a flowchart of a method for identifying implied skills from qualified talent profiles according to an implementation of the disclosure.

FIG. 6 depicts a block diagram of a computer system operating in accordance with one or more aspects of the present disclosure.

### DETAILED DESCRIPTION

A manually-crafted job description for advertising a job often suffers issues that may prohibit identification of the best job candidates for the job. For example, the job description may include overly-stringent or wish-list job skill requirements that may exclude certain qualified candidates from the job opening. Another issue is that the manually-crafted job description may not be suitable for cross-discipline hires. In certain situations, a talent profile of a candidate from another field may also be well qualified for the job opening. For example, a staff accountant who works at a cloud computing platform to help companies manage digital workflows for enterprise operations may be a qualified candidate for a director of financial planning and analysis (FP&A) at another cloud computing platform for enterprises. The HR manager may consider the director of FP&A as a leadership role. Although the staff accountant may be qualified for the director of FP&A job, the staff accountant is not considered to be a matching candidate because the staff accountant role performs a job function different than the stated role of the director of FP&A in a financial department. Further, the staff accountant is below the seniority of the job title in the job description. Finally, the manually-crafted job description may also suffer from generic job titles or skill descriptions. For example, certain job titles are specified in generic terms such as a member of service engineering, and certain job skills are defined generically (e.g., “great communication skills”). These generically-specified job titles and job skills are difficult to quantify when searching for a match from candidates.

Therefore, there is a need for technical solutions that solve the above-identified and other practical issues. Implementations of the disclosure use machine learning approaches to identify implied skills from talent profiles of persons who are proven qualified for the job (referred to as “qualified talent profiles” herein). The implied skills are not explicitly specified as requirements in a job description. Instead, the implied skills are computationally derived from the qualified talent profiles using a deep neural network. Implementations of the disclosure may add these computationally-identified implied traits (e.g., skills) to job descriptions so as to generate more precise job description, thus facilitating the organization to increase the pool of job candidates that may be qualified for the job. Here, the traits include desirable characteristics including skills from a qualified job candidates.

Implementations of the disclosure may include a system including one or more processing devices and one or more storage devices for storing instructions that when executed by the one or more processing devices cause the one or more processing devices to obtain a job description comprising requirements for a job, identify, based on at least one requirement in the job description, qualified talent profiles that each characterizes a corresponding qualified person for the job, calculate, by applying a deep neural network to each of the qualified talent profiles, embedding vectors, wherein each of the embedding vectors is associated with a linguistic unit in the qualified talent profiles, determine a cluster of embedding vectors based on a first similarity distance metric, determine linguistic units in a group of the qualified talent profiles, wherein each of the linguistic unit corresponds to one within the cluster of embedding vectors and represents a common traits among a group of qualified persons associated with the group of qualified talent profiles, and determine implied traits based on traits explicitly specified in the job description and common traits among the group of qualified persons.

The implied skills derived from qualified talent profiles can be used to supplement and/or substitute the skill requirements in the job description manually-crafted by the HR manager. In this way, rather than being limited to the job description hand-crafted by the HR manager based on conscious or unconscious subjective standards, the system and method may automatically generate enriched job descriptions objectively learned from the qualified talent profiles, thereby achieving more precise job descriptions that are used to increase the pool of job candidates to include those who possess these implied skills.

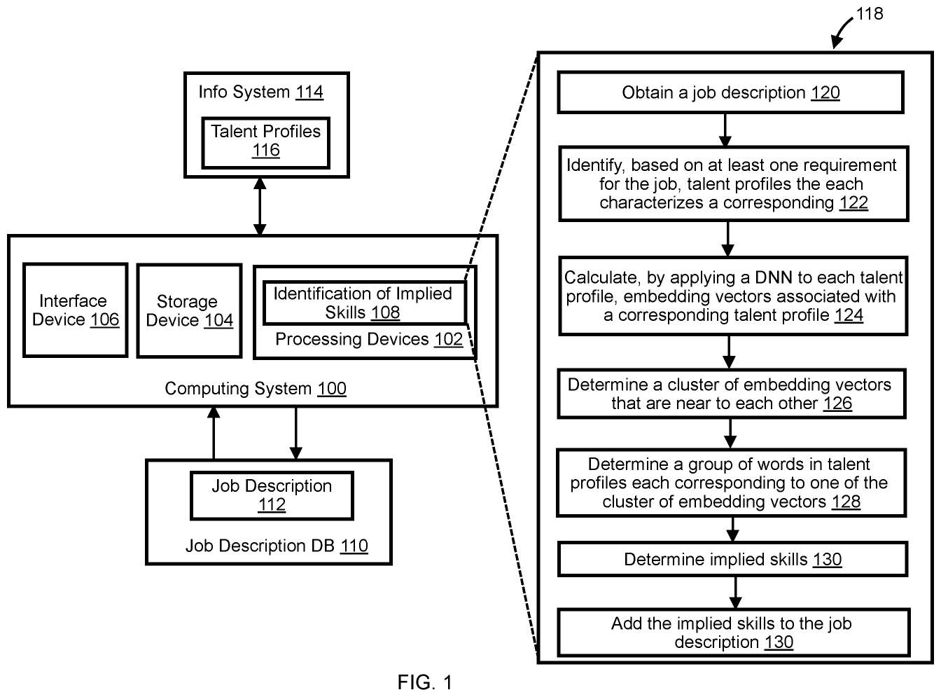

FIG. 1 illustrates a computing system 100 implementing a software application for identification of implied skills 108 according to an implementation of the disclosure. Computing system 100 can be a standalone computer or a networked computing resource implemented in a computing cloud. Referring to FIG. 1, computing system 100 may include one or more processing devices 102, a storage device 104, and an interface device 106, where the storage device 104 and the interface device 106 are communicatively coupled to processing devices 102.

A processing device 102 can be a hardware processor such as a central processing unit (CPU), a graphic processing unit (GPU), or an accelerator circuit. Interface device 106 can be a display such as a touch screen of a desktop, laptop, or smart phone. Storage device 104 can be a memory device, a hard disc, or a cloud storage connected to processing device 102 through a network interface card (not shown).

Processing device 102 can be a programmable device that may be programmed to implement a graphical user interface presented on interface device 106. The interface device may include a display screen for presenting textual and/or graphic information. Graphical user interface (“GUI”) allows a user using an input device (e.g., a keyboard, a mouse, and/or a touch screen) to interact with graphic representations (e.g., icons) presented on GUI.

Computing system 100 may be connected to one or more information systems 110, 114 through a network (not shown). These information systems can be human resource management (HRM) systems that are associated with one or more organizations that hire or seek to hire employee candidates to form their workforces (referred to as “talents”). The HRM systems can track external/internal candidate information in the pre-hiring phase (e.g., using an applicant track system (ATS)), or track employee information after they are hired (e.g., using an HR information system (HRIS)). Thus, these information systems may include databases that contain information relating to candidates and current employees.

Referring to FIG. 1, information system 114 can be an HRM system of an organization that may desire to hire new employees or retain existing employees with competitive and fair compensation. Information system 114 may include a database that stores the talent profiles 116 associated with job candidates or existing employees. Each of talent profiles 116 can be a data object that contains data values (referred to as feature values) related to a candidate or an employee. In this disclosure, the features can be sections of information. Examples of features may include job title, employer, skills, years of experience possessing the skills, college, postgraduate university etc. The feature values are the values associated with features or different categories. Examples of feature values may be “analyst,” “group manager,” “lab director,” “program manager” etc. as values for the “job title” feature; “1 year,” “2-4 years” etc. as values for the “years of experiences” feature. Other feature values may be similarly specified. In one implementation, talent profile 116 may include a resume. In other implementations, the talent profile 116 may include the resume and other information collected from other sources beyond the resume, and/or predicted feature values calculated based on the resume and the other information collected from other sources.

In some implementations, the talent profile 116 may be used to characterize a person (e.g., a candidate or an employee). The talent profile 116 may include feature values such as a job title currently held by the person and job titles previously held by the person, companies and teams to which the person previously belonged and currently belongs, descriptions of projects on which the person worked on, the technical or non-technical skills possessed by the person for performing the jobs held by the person, and the location (e.g., city and state) of the person. The talent profile 116 may further include other feature values such as the person's education background information including schools he or she has attended, fields of study, and degrees obtained. The talent profile 116 may further include other professional information of the employee such as professional certifications the employee has obtained, achievement awards, professional publications, and technical contributions to public forum (e.g., open source code contributions). Talent profile 116 may also include predicted feature values that indicate the likely career progress path through the organization if the person stays with the organization for a certain period of time.

Computing system 100 may be connected to a job description database 110 of an organization that may be in the job market to hire employees to fill job openings of the organization. The job description database 110 can be part of or separate from information system 114. The job description database 110 may include one or more job descriptions (also referred to as job profiles) 112 associated with job openings. Each job description 112 may specify different attributes required or desired from candidates to fill the corresponding job opening. In one implementation, a job description 112 may include job requirements such as job titles, teams to which the hire belongs to, projects on which the hire works, job functions, required skills and experience, requisite education/degrees/certificates/licenses etc. The job profiles may also include desired personality traits of the candidates such as leadership attributes, social attributes, and altitudes. In addition to these explicit requirements that can be specified in a textual description, a job profile may also include the talent profiles of employees that had been hired for the same or similar positions and the talent profiles of candidates that the organization considered to hire. According to an implementation of the disclosure, these talent profiles may contain information such as implied skills that can be identified by a deep neural network. The implied skills are those that are not explicitly specified in the job description 112. Instead, the implied skills are computationally derived by processing device 102 performing operations of software application 108 for identification of implied skills.

In one implementation, software application 108 may include operations 118 for identification of implied skills computationally derived from talent profiles of qualified person with respect to a job description 112. Processing device 102 may execute software application 108 to perform operations 118. At 120, processing device 102 may obtain a job description 112 from job description database 110. An author (e.g., a human resource (HR) manager) may compose the job description 112 in response to a hiring need of the organization. The hiring need may be created to fulfill a certain function within the organization. The function can be, for example, a project manager for software development, a marketing director, a financial analyst etc. The job description 112 may include textual description of different requirements for performing the job. The requirements may include, but not limited to, job titles, teams to which the hire belongs to, projects on which the hire works, job functions, required skills and experiences, requisite education, degrees, certificates, licenses etc. Additionally, processing devices 102 may enhance the job description 112 with additional information such as desired personality traits of the candidates such as leadership attributes, social attributes, and altitudes, as well as the talent profiles of employees that had been hired for the same or similar positions and the talent profiles of candidates that the organization considered to hire. Typically, job description 112 is handcrafted by the author based on the person's experience and knowledge. Thus, the scope of the handcrafted job description 112 may be limited to the author's experience and knowledge, and may miss certain helpful skills beyond the person's experience and knowledge at the time drafting the job description.

Implementations of the disclosure overcome these deficiencies and limitations of the human authors by supplement the job description with implied traits (e.g., skills in particular) computationally derived from talent profiles of persons who are proven to be qualified for the job. To this end, at 122, processing device 102 may identify, based on at least one requirement in the job description, talent profiles that each characterizes a corresponding qualified person for the job. The qualified persons for the job may include those employees that already perform the function of the job within the organization or persons who perform identical or similar functions in other organizations.

The talent profiles of the qualified persons may have been already stored in information system 114. Each talent profile 116 can characterize aspects of a corresponding person. In one implementation, the talent profile 116 may include feature values such as a job title currently held by the person and job titles previously held by the person, companies and teams to which the person previously belonged and currently belongs, descriptions of projects on which the person worked on, the technical or non-technical skills possessed by the person for performing the jobs held by the person, and the location (e.g., city and state) of the person. The talent profile 116 may further include other feature values such as the person's education background information including schools he or she has attended, fields of study, and degrees obtained. The talent profile 116 may further include other professional information of the employee such as professional certifications the employee has obtained, achievement awards, professional publications, and technical contributions to public forum (e.g., open source code contributions). Talent profile 116 may also include predicted feature values that indicate the likely career progress path through the organization if the person stays with the organization for a certain period of time.

The qualified persons can be identified based on at least one requirement in the job description. The at least one requirements in the job description can be, for example, the job title or a certain necessary criteria (e.g., a programming skill) for the job. In one implementation, processing device 102 may run a database search engine. The search engine may receive a query entered through a user interface presented on interface device 106, where the query may include the at least one requirement. Based on the query, the database search engine may retrieve talent profiles from information system 114 that match the query, thus identifying the talent profiles characterizing qualified persons for the job. In one implementation, the job title can be used as the requirement for determining the qualified persons. For example, if the job title is a software project manager, processing device 102 may use the search engine to identify the software project managers who have been hired within a pre-determined period of time (e.g., in the past year). These recently-hired software project managers may constitute part of the qualified persons for the job. The search engine may further identify people who have been hired within a pre-determined period of time with a job title similar to the software project manager. The system may use a semantic relation map to determine job titles that are similar to the software project manager title. These people with a job title similar to the software project manager title may also constitute part of the qualified persons, thus increasing the number of qualified talent profiles. Additionally, the HR manager may also hand pick certain people as part of the qualified persons for the job. The qualified persons can be employees of the organization or people outside the organization. The talent profiles of these identified qualified persons may be retrieved from information system 114.

The qualified talent profiles can be documents that are quite long and often include linguistic units (e.g., words, phrases) having a similar meaning in the context of a document. For example, the qualified talent profiles may include skills that may be described in different words but represent identical or similar skills. Implementations of the disclosure may use neural networks to map the qualified talent profiles into a compact dimension of numerical values (e.g., vectors of numerical values) which may be used to extract words with similar meanings. The identified groups of words with identical or similar meanings may be used to determine the implied skills (or skills not specified in the job description) of the qualified talent profiles that are most relevant to the requirements of the job description and are most prevalent in the qualified talent profiles. At 124, processing device 102 may further calculate, by applying a deep neural network (DNN) to each qualified talent profile, embedding vectors associated with the qualified talent profile. The embedding vector in this disclosure is a vector of numerical values representing the meaning of a word or a segment of words (e.g., a phrase) in the linguistic context of a talent profile. The word or phrase may represent a trait including a skill specified in the talent profile. In some implementation, the context can be a section (e.g., the skill section, the narratives of work experience, the narratives of projects, the narratives of education) of a talent profile. The deep neural network can be a suitable type of neural network module that can be trained using training data.

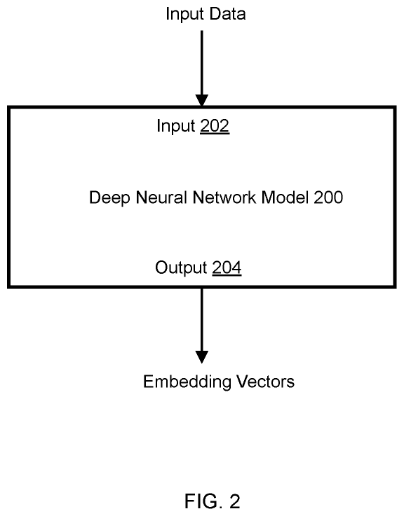

FIG. 2 illustrates a neural network module 200 that may be used to calculate embedding vectors according to an implementation of the disclosure. The neural network module 200 may be a deep neural network (DNN) that may include multiple layers, in particular including an input layer for receiving data inputs, an output layer for generating outputs, and one or more hidden layers that each includes linear or non-linear computation elements (referred to as neurons) to perform the DNN computation propagated from the input layer to the output layer that may transform the data inputs to the outputs. Two adjacent layers may be connected by edges. Each of the edges may be associated with a parameter value (referred to as a synaptic weight value) that provide a scale factor to the output of a neuron in a prior layer as an input to one or more neurons in a subsequent layer.

Referring to FIG. 2, neural network module 200 may include an input layer including an input 202 to receive, as input data, a qualified talent profile associated with a qualified person. As discussed above, the talent profile is a data object including entries specifying different aspects of the qualified person. The qualified talent profile may include sections describing different aspects of the corresponding person. The information relating to the applicant may include feature values obtained from the HR database and may also include feature values obtained from external data sources such as professional web page, publications, and professional contributions to the public domains. The neural network module 200 may include an output layer including output 204 to produce embedding vectors each of which may correspond to a word or a collection of words (like sections) and represent the meaning in a compact dimension.

In one implementation, the deep neural network is realized using a general purpose machine learning model called Bidirectional Encoder Representations from Transformers (BERT) model. In this disclosure, the BERT model includes different variations of BERT models including, but not limited to, ALBERT (a Lite BERT for Self-Supervised Learning of Language Representations), ROBERTA (Robustly Optimized BERT Pretraining Approach), and DistillBERT (a distilled version of BERT). The BERT models are particularly suitable for natural language processing (NLP).

Previously, NLP machine learning models (e.g., recurrent neural networks (RNNs)) sequentially examine the words in a document in one direction—i.e., from left to right, from right to left, or a combination of left to right and then right to left. This one-directional approach may work well for certain tasks. To achieve deeper understanding of the underlying text, BERT models employ bidirectional training. Instead of identifying the next word in a sequence of words, the training of BERT models may use a technique called Masked Language Modeling (MLM) that may randomly mask words in a sentence and then try to predict the masked words from other words in the sentence surrounding the masked words from both left and right of the masked words. Thus, the training of the BERT models takes into consideration words from both direction simultaneously during the training process.

A linguistic unit such as a word or a phrase may be represented using an embedding vector which can be a vector of numerical values computationally derived based on a linguistic model. The linguistic model can be context-free or context-based. An example of the context-free model is word2vec that may be used to determine the vector representation for each word in a vocabulary. In contrast, context-based models may generate an embedding vector associated with word based on other words in a context (e.g., a paragraph). In BERT, the embedding vector associated with a word may be calculated based on other words within the input document using the previous context and the next context.

A transformer neural network (referred to as the “Transformer” herein) is designed to overcome the deficiencies of the recurrent neural network (RNN) and/or the convolutional neural network (CNN) architectures, thus achieving the determination of word dependencies among all words in a sentence with fast implementations using TPUs and GPUs. The Transformer may include encoders and decoders (e.g., six encoders and six decoders), where encoders have identical or very similar architecture, and decoders may also have identical or very similar architecture. The encoders may encode the input data into an intermediate encoded representation, and the decoder may convert the encoded representations to a final result. An encoder may include a self-attention layers and a feed forward layer. The self-attention layers may calculate attention scores associated with a word. The attention scores, in the context of this disclosure, measure the relevance values between the word and each of the other words in the sentence. Each relevance may be represented in the form of a weight value.

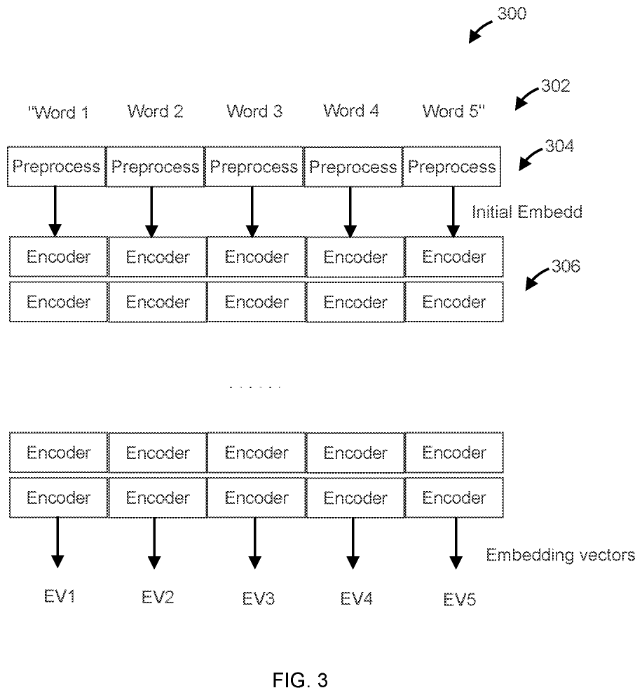

FIG. 3 illustrates a Bidirectional Encoder Representations from Transformers (BERT) model 300 that may be trained to convert words or phrases into embedding vectors according to an implementation of the disclosure. Referring to FIG. 3, BERT model 300 may include a preprocessing layer 304 and multiple encoder layers 306. Preprocessing layer 304 may receive a stream of linguistic units (e.g., a section composed of words in a qualified talent profile), and convert each linguistic unit in the stream into a vector of combining the tokenization values, the index values, and the position values. For example, preprocessing layer 304 may obtain a stream of words 302 (e.g., Word 1, . . . , Word 5) as input to be converted into embedding vectors that each represents a corresponding word.

In one implementation, preprocessing layer 304 may include one or more sub-layers of a token embedding layer, a segment embedding layer, and a position embedding layer. The token embedding layer may convert a word into a vector of token values, where the vector of token values has a predetermined dimension (e.g., a vector of 768 values). The token embedding layer may tokenize the word using a certain tokenization method such as the WordPiece method which is a data-driven method. The segment embedding layer may identify sentences and assign each sentence with an index value. Thus, each word in a sentence may be associated with an index value of the sentence. The index value associated with the word may take into consideration of the sentence structure in the qualified talent profile. The position embedding layer may assign each word with a position value within the sentence. In one implementation, the position embedding layer may include a look-up table of size (512, 768) where each row is a vector corresponding to a word at a position. Namely, the first row corresponds to a word at the first position in the sentence, and the second row corresponds to a word at the second position etc. The output of the token embedding layer, the segment embedding layer, and the position embedding layer may be combined (e g, summed together) to form initial embedding vectors as input to the encoder layers 306. Each word input (e.g., Word 1, . . . , Word 5) may have a corresponding initial embedding vector.

Encoder layers 306 may include multiple layers of encoders (e.g., 6 layers). The encoders may encode the input data into intermediate encoded representations. An encoder may include a self-attention layers and a feed forward layer. The self-attention layers may calculate attention scores associated with a word. The attention scores, in the context of this disclosure, measure the relevance values between the word and each of the other words in the sentence. Each relevance may be represented in the form of a weight value.

The self-attention layer may receive the intermediate representation of each word from a previous layer (or the preprocessing layer if the encoder layer is the first encoder layer). Each of the intermediate representation can be a type of word embedding which can be a vector including 512 data elements. The self-attention layer may further include a projection layer that may project the input word embedding vector into a query vector, a kay vector, and a value vector which each has a lower dimension (e.g., 64). The scores between a word and other words in the input sentence are calculated as the dot product between the query vector of the word and key vectors of all words in the input sentence. The scores may be fed to a Softmax layer to generate normalized Softmax scores that each determines how much each word in the input sentence expressed at the current word position. The attention layer may further include the multiplication operations that multiply the Softmax scores with each of the value vectors to generate the weighted scores that may maintain the value of words that are focused on while reducing the attentions to the irrelevant words. Finally, the self-attention layer may sum up the weighed scores to generate the attention values at each word position. The attention scores are provided to the feed forward layer which forwards the word embeddings of the present encoder layer to the next one. The calculations in the feed forward can be performed in parallel while the relevance between words is reflected in the attention scores. The eventual output of the stacked-up encoder layers 306 are the embedding vector (e.g., EV1, . . . , EV5) for each word. The embedding vectors that each include numerical values may capture the meaning of the word by taking into the context of the word in a sentence.

BERT models may be trained using bidirectional training. Instead of identifying the next word in a sequence of words, the training of BERT models may use a technique called Masked Language Modeling (MLM) that may randomly mask words in a sentence and then try to predict the masked words from other words in the sentence surrounding the masked words from both left and right of the masked words. Thus, the training of the BERT models takes into consideration words from both direction simultaneously during the training process.

Linguistic units of identical or similar meaning in the context may have embedding vectors close to each other in high-dimensional space (512 dimensions). In this way, the BERT model may be used to determine common skills in all of the qualified talent profiles. Referring to FIG. 1, at 126, processing device 102 may determine a cluster of embedding vectors that are near to each other in the space of embedding vectors. Each embedding vector may have a certain dimension (e.g., 512) of data values. In one implementation, each word in the talent profiles of the identified qualified persons may be mapped to a point in the high-dimensional space. Processing device 102 may perform clustering operations to determine clusters of points. For example, processing device 102 may perform nearest neighbor operations (e.g., k-nearest neighbors algorithm) to group the points into clusters. Each cluster of points may correspond to a group of words having identical or similar meaning.

At 128, processing device 102 may determine a group of linguistic units (e.g., words or phrases) in the qualified talent profiles corresponding to the embedding vector within a cluster. As discussed above, the group of linguistic units may represent identical or similar meaning in the context of the qualified talent profiles. These linguistic units having identical or similar meaning may represent the common traits of these qualified persons including common skills.

At 130, processing device 102 may determine implied traits based on the job description and the group of words determined from the qualified talent profiles. The group of linguistic units may represent the common traits of these qualified persons, where the common traits may include the common skills. By comparing the common traits possessed by these qualified persons with the traits explicitly specified in the job description, processing device 102 may determine the implied traits possessed by these qualified persons. The implied traits are the common traits possessed by these qualified persons but are not in the job description.

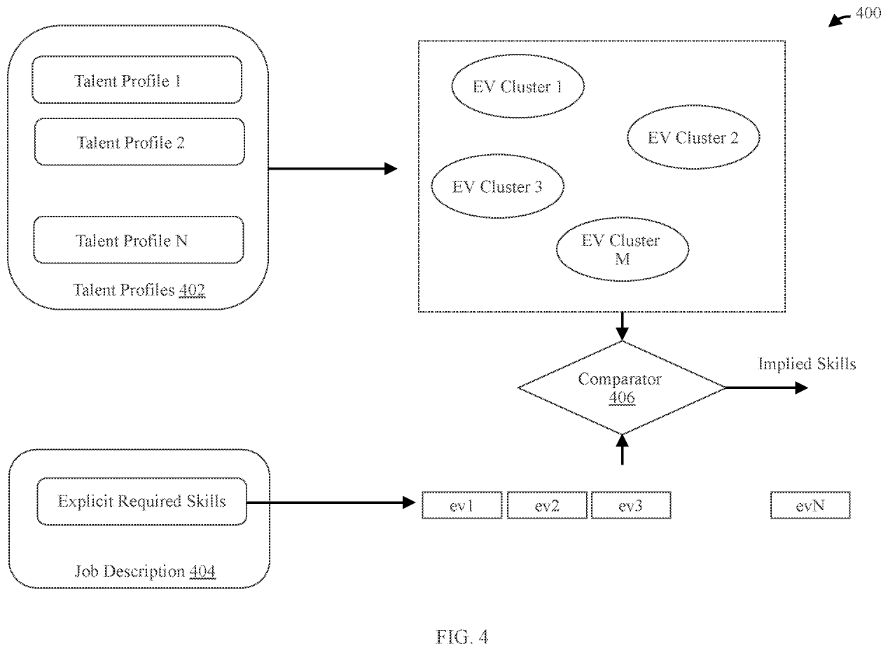

In one implementation, to compare the common traits possessed by these qualified persons with the traits explicitly specified in the job description, processing device 102 may first execute a BERT model to convert the job description into embedding vectors, and then compare the common traits with the traits explicitly specified in the job description using the embedding vectors. FIG. 4 illustrates a system 400 for comparing the job description with qualified talent profiles using embedding vectors according to an implementation of the disclosure. Referring to FIG. 4, system 400 may include storage devices for storing qualified talent profiles 402 (e.g., talent profiles 1, . . . , N) and job description 404. The job description 404 may further include explicitly specified traits for a job opening. In one implementation, as discussed above, linguistic units (e.g., words or phrases) in qualified talent profiles 402 (talent profiles 1, . . . , N) may each be converted by using encoders of a BERT model into embedding vectors. The embedding vectors may be grouped into clusters of embedding vectors (e.g., EV clusters 1, . . . , M). These clusters may be generated using an exact or an approximate technique for performance reasons. Each cluster of these embedding vectors may represent a common trait (e.g., a common skill) among the qualified talent profiles. Correspondingly, the processing device may identify a section (e.g., skill section) in the job description 404, where the section may explicitly specify traits (e.g., skills) required or desired for the job. Similarly, the linguistic units (e.g., words or phrases representing skills) in the section of the job description 404 may each be converted by using encoders of a BERT model into embedding vectors (e.g., ev 1, . . . , N). The processing device may further use comparator 406 to compare embedding vectors (e.g., ev 1, . . . , N) corresponding to traits explicitly specified in the job description 404 with clusters of embedding vectors (EV Clusters 1, . . . , M). In one implementation, comparator 406 may calculate a similarity distance (e.g., a cosine similarity distance) between each embedding vector (ev 1, . . . , N) representing an explicitly specified trait and each embedding vector cluster (EV clusters 1, . . . , M) corresponding a common trait (e.g., a common skill) in the qualified talent profile. This similarity distance may indicate how similar the common trait to the specified trait. If the similarity distance between a common trait and all the explicitly specified traits is larger than a predetermined threshold, the processing device may determine that the common trait is an implied trait. Such identified implied traits (e.g., skills) may be a helpful addition to the job description 404. This addition can improve the recommendations downstream.

Referring to FIG. 1, at 132, processing device 102 may add these implied traits to the job description, thus further enhancing the job description. These implied traits may help increase the talent pool of candidates and attract more qualified candidates to apply for the job.

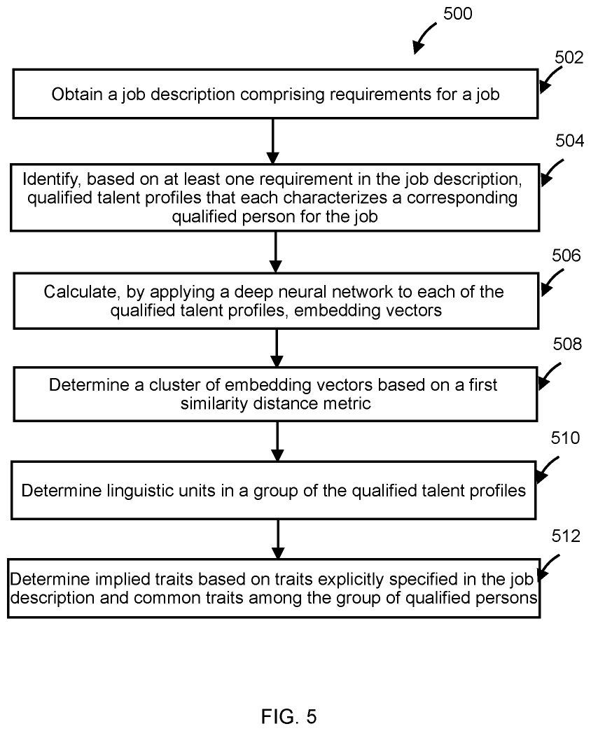

FIG. 5 illustrates a flowchart of a method 500 for identifying implied skills from qualified talent profiles according to an implementation of the disclosure. Method 500 may be performed by processing devices that may comprise hardware (e.g., circuitry, dedicated logic), computer readable instructions (e.g., run on a general purpose computer system or a dedicated machine), or a combination of both. Method 500 and each of its individual functions, routines, subroutines, or operations may be performed by one or more processors of the computer device executing the method. In certain implementations, method 500 may be performed by a single processing thread. Alternatively, method 500 may be performed by two or more processing threads, each thread executing one or more individual functions, routines, subroutines, or operations of the method.

For simplicity of explanation, the methods of this disclosure are depicted and described as a series of acts. However, acts in accordance with this disclosure can occur in various orders and/or concurrently, and with other acts not presented and described herein. Furthermore, not all illustrated acts may be needed to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term “article of manufacture,” as used herein, is intended to encompass a computer program accessible from any computer-readable device or storage media.

As shown in FIG. 5, one or more processing devices may, at 502, implement a sequence of transformer neural networks. In particular, the one or more processing devices may obtain a job description comprising requirements for a job.

At 504, the one or more processing devices may identify, based on at least one requirement in the job description, qualified talent profiles that each characterizes a corresponding qualified person for the job.

At 506, one or more processing devices may calculate, by applying a deep neural network to each of the qualified talent profiles, embedding vectors, wherein each of the embedding vectors is associated with a linguistic unit in the qualified talent profiles.

At 508, one or more processing devices may determine a cluster of embedding vectors based on a first similarity distance metric.

At 510, one or more processing devices may determine linguistic units in a group of the qualified talent profiles, wherein each of the linguistic unit corresponds to one within the cluster of embedding vectors and represents a common traits among a group of qualified persons associated with the group of qualified talent profiles.

At 512, one or more processing devices may determine implied traits based on traits explicitly specified in the job description and common traits among the group of qualified persons.

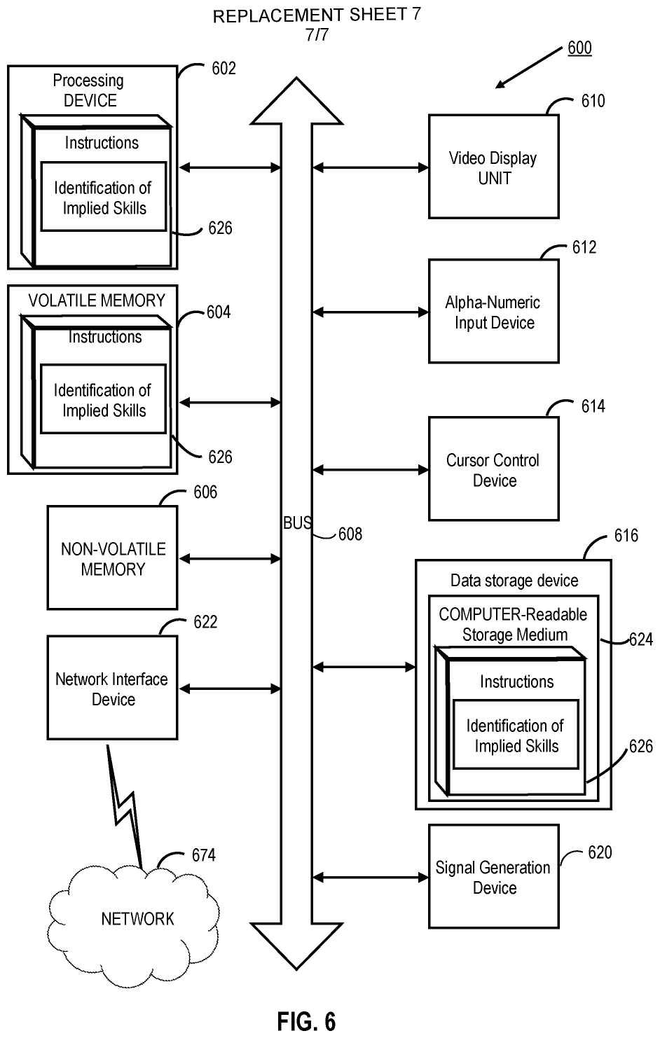

FIG. 6 depicts a block diagram of a computer system 600 operating in accordance with one or more aspects of the present disclosure. In various illustrative examples, computer system 600 may implement operations 118 for identification of implied skills as shown in FIG. 1.

In certain implementations, computer system 600 may be connected (e.g., via a network, such as a Local Area Network (LAN), an intranet, an extranet, or the Internet) to other computer systems. Computer system 600 may operate in the capacity of a server or a client computer in a client-server environment, or as a peer computer in a peer-to-peer or distributed network environment. Computer system 600 may be provided by a personal computer (PC), a tablet PC, a set-top box (STB), a Personal Digital Assistant (PDA), a cellular telephone, a web appliance, a server, a network router, switch or bridge, or any device capable of executing a set of instructions (sequential or otherwise) that specify actions to be taken by that device. Further, the term “computer” shall include any collection of computers that individually or jointly execute a set (or multiple sets) of instructions to perform any one or more of the methods described herein.

In a further aspect, the computer system 600 may include a processing device 602, a volatile memory 604 (e.g., random access memory (RAM)), a non-volatile memory 606 (e.g., read-only memory (ROM) or electrically-erasable programmable ROM (EEPROM)), and a data storage device 616, which may communicate with each other via a bus 608.

Processing device 602 may be provided by one or more processors such as a general purpose processor (such as, for example, a complex instruction set computing (CISC) microprocessor, a reduced instruction set computing (RISC) microprocessor, a very long instruction word (VLIW) microprocessor, a microprocessor implementing other types of instruction sets, or a microprocessor implementing a combination of types of instruction sets) or a specialized processor (such as, for example, an application specific integrated circuit (ASIC), a field programmable gate array (FPGA), a digital signal processor (DSP), or a network processor).

Computer system 600 may further include a network interface device 622. Computer system 600 also may include a video display unit 610 (e.g., an LCD), an alphanumeric input device 612 (e.g., a keyboard), a cursor control device 614 (e.g., a mouse), and a signal generation device 620.

Data storage device 616 may include a non-transitory computer-readable storage medium 624 on which may store instructions 626 encoding any one or more of the methods or functions described herein, including instructions for performing operations 118 of FIG. 1 for implementing method 500.

Instructions 626 may also reside, completely or partially, within volatile memory 604 and/or within processing device 602 during execution thereof by computer system 600, hence, volatile memory 604 and processing device 602 may also constitute machine-readable storage media.

While computer-readable storage medium 624 is shown in the illustrative examples as a single medium, the term “computer-readable storage medium” shall include a single medium or multiple media (e.g., a centralized or distributed database, and/or associated caches and servers) that store the one or more sets of executable instructions. The term “computer-readable storage medium” shall also include any tangible medium that is capable of storing or encoding a set of instructions for execution by a computer that cause the computer to perform any one or more of the methods described herein. The term “computer-readable storage medium” shall include, but not be limited to, solid-state memories, optical media, and magnetic media.

The methods, components, and features described herein may be implemented by discrete hardware components or may be integrated in the functionality of other hardware components such as ASICS, FPGAs, DSPs or similar devices. In addition, the methods, components, and features may be implemented by firmware modules or functional circuitry within hardware devices. Further, the methods, components, and features may be implemented in any combination of hardware devices and computer program components, or in computer programs.

Unless specifically stated otherwise, terms such as “receiving,” “associating,” “determining,” “updating” or the like, refer to actions and processes performed or implemented by computer systems that manipulates and transforms data represented as physical (electronic) quantities within the computer system registers and memories into other data similarly represented as physical quantities within the computer system memories or registers or other such information storage, transmission or display devices. Also, the terms “first,” “second,” “third,” “fourth,” etc. as used herein are meant as labels to distinguish among different elements and may not have an ordinal meaning according to their numerical designation.

Examples described herein also relate to an apparatus for performing the methods described herein. This apparatus may be specially constructed for performing the methods described herein, or it may comprise a general purpose computer system selectively programmed by a computer program stored in the computer system. Such a computer program may be stored in a computer-readable tangible storage medium.

The methods and illustrative examples described herein are not inherently related to any particular computer or other apparatus. Various general purpose systems may be used in accordance with the teachings described herein, or it may prove convenient to construct more specialized apparatus to perform method 300 and/or each of its individual functions, routines, subroutines, or operations. Examples of the structure for a variety of these systems are set forth in the description above.

The above description is intended to be illustrative, and not restrictive. Although the present disclosure has been described with references to specific illustrative examples and implementations, it will be recognized that the present disclosure is not limited to the examples and implementations described. The scope of the disclosure should be determined with reference to the following claims, along with the full scope of equivalents to which the claims are entitled.

What is claimed is:

1. A system comprising one or more processing devices and one or more storage devices for storing instructions that when executed by the one or more processing devices cause the one or more processing devices to:
obtain a job description comprising requirements for a job;
identify, based on at least one requirement in the job description, qualified talent profiles that each characterizes a corresponding qualified person for the job;
calculate, by applying a deep neural network to each of the qualified talent profiles, embedding vectors, wherein each of the embedding vectors is associated with a linguistic unit in the qualified talent profiles;
determine a cluster of embedding vectors based on a similarity distance metric;
determine linguistic units in a group of the qualified talent profiles, wherein each of the linguistic unit corresponds to one within the cluster of embedding vectors and represents a common trait among a group of qualified persons associated with the group of qualified talent profiles; and
determine implied traits based on traits explicitly specified in the job description and common traits among the group of qualified persons.

2. The system of claim 1, wherein the processing device is further to add the implied traits to the job description.

3. The system of claim 1, wherein the common traits comprise skills that are common to the group of qualified talent profiles, the traits explicitly specified in the job description comprise skills explicitly specified in the job description, and the implied traits comprise implied skills that are common among the group of qualified talent profiles but are absent from the job description.

4. The system of claim 1, wherein the at least one requirement in the job description comprises a job title for the job, and the linguistic unit comprises at least one of a word or a phrase.

5. The system of claim 1, wherein the qualified persons comprise at least one of an employee who currently perform job functions of the job description in the organization or a person who performs job functions similar to those in the job description in the organization or in another organization.

6. The system of claim 1, wherein the deep neural network comprises a Bidirectional Encoder Representation from Transformers (BERT) network, and the BERT network comprises a preprocessing layer and one or more encoder layers.

7. The system of claim 6, wherein to calculate, by applying a deep neural network to each of the qualified talent profiles, embedding vectors, wherein each of the embedding vectors is associated with a linguistic unit in the qualified talent profiles, the processing device is to:
provide each of the qualified talent profiles to the preprocessing layer of the BERT network to generate initial embedding vectors, wherein each of the initial embedding vectors corresponds to a respective linguistic unit in each of the qualified talent profiles; and
propagate the initial embedding vectors through the one or more encoder layers to generate the embedding vectors, wherein each of the embedding vector comprises a predetermined number of numerical values.

8. The system of claim 1, wherein to determine a cluster of embedding vectors based on a similarity distance metric, the processing device is to determine the cluster based on nearest neighbors of the embedding vectors.

9. The system of claim 1, wherein to determine linguistic units in a group of the qualified talent profiles, wherein each of the linguistic unit corresponds to one within the cluster of embedding vectors and represents a common traits among a group of qualified persons associated with the group of qualified talent profiles, and to determine implied traits based on traits explicitly specified in the job description and common traits among the group of qualified persons, the processing device is to:
identify a section of skill requirements in the job description;
provide the section of skill requirements to the BERT network to generate embedding vectors corresponding to the skill requirements; and
compare the embedding vectors corresponding to the skill requirements with the cluster of embedding vectors to determine the implied traits.

10. The system of claim 1, wherein the deep neural network is trained using training data by iteratively adjusting at least one parameters of the deep neural network.

11. A method comprising:
obtaining a job description comprising requirements for a job;
identifying, based on at least one requirement in the job description, qualified talent profiles that each characterizes a corresponding qualified person for the job;
calculating, by a processing device applying a deep neural network to each of the qualified talent profiles, embedding vectors, wherein each of the embedding vectors is associated with a linguistic unit in the qualified talent profiles;
determining a cluster of embedding vectors based on a similarity distance metric;
determining linguistic units in a group of the qualified talent profiles, wherein each of the linguistic unit corresponds to one within the cluster of embedding vectors and represents a common trait among a group of qualified persons associated with the group of qualified talent profiles; and
determining implied traits based on traits explicitly specified in the job description and common traits among the group of qualified persons.

12. The method of claim 11, further comprising adding the implied traits to the job description.

13. The method of claim 11, wherein the common traits comprise skills that are common to the group of qualified talent profiles, the traits explicitly specified in the job description comprise skills explicitly specified in the job description, and the implied traits comprise implied skills that are common among the group of qualified talent profiles but are absent from the job description.

14. The method of claim 11, wherein the at least one requirement in the job description comprises a job title for the job, and the linguistic unit comprises at least one of a word or a phrase.

15. The method of claim 11, wherein the qualified persons comprise at least one of an employee who currently perform job functions of the job description in the organization or a person who performs job functions similar to those in the job description in the organization or in another organization.

16. The method of claim 11, wherein the deep neural network comprises a Bidirectional Encoder Representation from Transformers (BERT) network, and the BERT network comprises a preprocessing layer and one or more encoder layers.

17. The method of claim 16, wherein calculating, by a processing device applying a deep neural network to each of the qualified talent profiles, embedding vectors, wherein each of the embedding vectors is associated with a linguistic unit in the qualified talent profiles further comprises:
providing each of the qualified talent profiles to the preprocessing layer of the BERT network to generate initial embedding vectors, wherein each of the initial embedding vectors corresponds to a respective linguistic unit in each of the qualified talent profiles; and
propagating the initial embedding vectors through the one or more encoder layers to generate the embedding vectors, wherein each of the embedding vector comprises a predetermined number of numerical values.

18. The method of claim 11, wherein determining a cluster of embedding vectors based on a similarity distance metric comprises determining the cluster based on nearest neighbors of the embedding vectors.

19. The method of claim 11, wherein determining linguistic units in a group of the qualified talent profiles, wherein each of the linguistic unit corresponds to one within the cluster of embedding vectors and represents a common traits among a group of qualified persons associated with the group of qualified talent profiles, and determining implied traits based on traits explicitly specified in the job description and common traits among the group of qualified persons further comprises:
identifying a section of skill requirements in the job description;
providing the section of skill requirements to the BERT network to generate embedding vectors corresponding to the skill requirements; and
comparing the embedding vectors corresponding to the skill requirements with the cluster of embedding vectors to determine the implied traits.

20. A machine-readable non-transitory storage media encoded with instructions that, when executed by one or more processing devices, cause the one or more processing devices to:
obtain a job description comprising requirements for a job;
identify, based on at least one requirement in the job description, qualified talent profiles that each characterizes a corresponding qualified person for the job;
calculate, by applying a deep neural network to each of the qualified talent profiles, embedding vectors, wherein each of the embedding vectors is associated with a linguistic unit in the qualified talent profiles;
determine a cluster of embedding vectors based on a similarity distance metric;
determine linguistic units in a group of the qualified talent profiles, wherein each of the linguistic unit corresponds to one within the cluster of embedding vectors and represents a common trait among a group of qualified persons associated with the group of qualified talent profiles; and
determine implied traits based on traits explicitly specified in the job description and common traits among the group of qualified persons.
